(19) United States
(12) Patent Application Publication
(10) Pub. No.: US 2010/0247715 A1
(43) Pub. Date: Sep. 30, 2010

(54) Long Container for Consumable Substances

(76) Inventor: Mario Pastor Muntada, Barcelona (ES)

Correspondence Address: RICHARD M. GOLDBERG, 25 EAST SALEM STREET, SUITE 419, HACKENSACK, NJ, 07601, US

(21) Appl. No.: 12/743,420

(22) PCT Filed: Nov. 17, 2008
(86) PCT No.: PCT/ES2008/000729

§ 371 Date: May 18, 2010

(30) Foreign Application Priority Data
Dec. 5, 2007 (ES) P200703338

(51) Int. Cl. B65D 83/00; B65D 85/00; A24F 47/00; A23G 3/56

(52) U.S. Cl. 426/87; 426/135; 426/120; 426/104

(57) ABSTRACT

Elongated container for consumables (FIGS. 1, 2 and 3) including a consumption article similar in size and shape to a cigarette, which is used by absorbing the product it contains, after applying it to the lips of the person who wants to taste it, such that it is manufactured, preferably, with multilayer sheets of cellulose, aluminium and polyethylene, although sheets with one, two or more layers can be used, including a cylindrically shaped, hollow, elongated body (1), plugged at both ends thereof with absorption mouthpieces (2) and seals (3) intended to conserve consumable (4). Several variations are offered with liquid, gaseous and solid consumables, capillary take-up wicks (5), aroma emitters (6), stoppers (8) and air inlet valves (7). The container is also provided, in that the consumable, in compliance with health and legal regulations, covers the whole range of products including preventive and curative medicinal products.

The aim of this invention relates to a new article for personal use that is small in size, similar to the size of a cigarette; in other words, with an essentially cylindrical, elongated shape, which instead of containing tobacco enclosed in cigarette paper, it contains consumables that may be solids, liquids with greater or less viscosity and also gaseous products. These products are stored in a non-deformable wrapping that has a certain consistency and which is used by applying it to the lips to slowly suck the contents until they are finished, at which point it is removed so that a new one can be consumed when desired.

### TECHNICAL SECTOR TO WHICH THE INVENTION RELATES

This invention relates to Life's Current Needs Sector, which is part of the food industry relating both to sweet-like products and to food products that are concentrated, pressed on their own and mixed, lyophilized, dehydrated and others, influencing from an industrial point of view, the production of confectionery products to be consumed by the public in general and the production of concentrated food products. Depending on the consumable product, it can also affect medical sciences such as pharmaceutical products.

### BACKGROUND TO THE INVENTION

There is very little background material in the field to which this invention relates. The most similar article owing to its shape is obviously the classical cigarette, but this cannot be compared with the proposed elongated container. It is true that there are articles that can be used as cigarette substitutes for preventing the current diseases stemming from tobacco consumption. There is a certain type of people who manage to give up the smoking habit without giving up the habit of always having something in their mouth, such as a simple toothpick or the like.

So the author of this invention has a similar idea entitled “impregnated toothpick”, which can be consulted on the Spanish Patent and Trademark Office database, under reference U 200700320.

Another article that is reminiscent of this invention is the one known as a smokers' mouthpiece, or cigarette holder, which appeared for various reasons. On the one hand, it was to try and avoid staining your fingers with the nicotine from the cigarette. However, this article was also used to include a filter that partially eliminated the hazardous effects of nicotine. The fashion for mouthpieces was very popular during the middle of 20th century and it even became an element of distinction, with mouthpieces being manufactured from elegant materials such as gold, silver, lacquer, amber, tortoiseshell and many more, although the most frequent were made from bone, box tree wood or bakelite.

And as part of this mouthpiece tradition, even those that were not useful for holding a cigarette or cigar became popular, as they were only offered to those who wanted to give up smoking, so also, like a container, they were filled with menthol or similar substances and the aromatic vapour of the product contained inside it could be absorbed slowly.

This invention is reminiscent, to a certain degree, of these earlier mouthpieces but, nevertheless, differences apart, this is a completely new article with a multitude of possibilities and variations as manifested below.

### DESCRIPTION OF THE INVENTION

This invention, as explained in the introduction, relates to a new type of consumable article, which is reminiscent of the shape of a classic cigarette and is similar in size, which is used by holding it in your fingers and applying it to the lips to slowly suck the contents thereof until it is finished, when it is thrown away and a new one can be started immediately or after a short time. In other words, it is one of the so-called disposable articles. In principle, the inventor contemplates a form of distribution that is also similar to cigarette distribution; in other words, in packets or small, different sized boxes with labels so that it is easy to distinguish the contents and characteristics because, as we can see, the aim is to prepare a relatively wide range of contents, not only because the consumable can be available in a solid, liquid or gaseous state, but also because of its aromas, flavours, sizes and shapes.

As will be explained below, the container of the invention has an elongated, conical or straight cylindrical body with a circular, oval or elliptical section. This main body of the basic article is made from a multilayer element of the usual type found in today's market for containing liquid products and those solid products that are intended to be conserved for long periods of time. Preferably of the type that are made up of layers of cellulose, aluminium and polyethylene, which make it possible to form containers with a certain rigidity and body, and which are completely sealed. However, any material with one or various layers, among those currently available or which may be introduced in the future, can be valid, providing that they satisfy the appropriate conditions of consistency, impermeability and, in short, ideal properties for the prolonged conservation of the contained product.

The two ends of these containers are closed with a kind of plug, or where appropriate, valves coated with porous material for retaining the flavours which, under normal conditions, prevent the consumable inside the container from exiting, but which by virtue of a suction action allow said consumable to pass therethrough. Depending on the contents and the model used, as will be seen, there are various solutions for allowing the consumable product to exit the container by virtue of a simple suction action.

Each container can have one general volume or be divided into two parts with different products to make it more attractive.

When the content is gaseous, with pressurised packaging, the body must have more consistency and must be provided with valves that facilitate the suction process.

Solid containers are also contemplated, for one single product or a multi-product, with the option of adding an independent aroma emitter at one of the ends thereof, providing this is possible.

### BRIEF DESCRIPTION OF THE DRAWINGS

Three figures are included, which represent different alternatives that are contemplated in this invention.

FIG. 1

This figure represents various solutions with a liquid consumable.

1.a. Basic Container

This is an elongated container for consumables in its basic symmetrical design with a liquid contents, two rounded mouthpieces for absorption with their protective seals. The following is indicated:

1. Body of the container

2. Absorption mouthpiece

3. Seal

4. Consumable liquid

1.b. Basic Container with Capillary Take-Up Reinforcement

This is an identical container to the one above, which incorporates inside it a thread or wick for reinforcing the liquid capillary take-up. The following is indicated:

5. Wick

1.c. Container with Aroma Emitter

This is an elongated container for consumables with a basic asymmetrical design and a liquid contents, rounded mouthpiece for absorption with seal, and the opposite end is provided with an aroma emitter that is also sealed. A special valve is included to facilitate the inlet of air. The following is indicated:

6. Aroma emitter

7. Valve

1.d. Container with Aroma Emitter and Wick

This is an elongated container for consumables, identical to the one above, but incorporating the capillary take-up wick.

1.e. Container with Two Tanks

This container has a similar operating principle and use as the one in case 1.a, but it is divided into two parts to contain liquids with different characteristics. It has two mouthpieces for absorption and two seals. At the bottom a small valve can be seen on each side, which is needed to allow the inlet of air during the absorption process via the mouthpiece. An enlarged view of this valve is shown in its open and closed positions.

FIG. 2

This figure represents various solutions wherein instead of being a liquid, the consumable is a liquid gas or a solid.

1.f. Liquid Gas Container

This is a special container filled with gas in a vessel made of pressure-resistant material and fitted with a metering valve, all protected by a seal. The opposite end of the mouthpiece has an aroma emitter with its protective seal. A stopper is shown diagrammatically in the mouthpiece, which allows the gas to exit at the discretion of the consumer. The following is indicated:

8. Stopper

9. Liquid gas

1.g. Container with Solid Consistency and Protective Wrapping

This container is in fact a solid product with a protective wrapping that can be removed in sections gradually as it is consumed. The following is indicated:

10. Wrapping

11. Pre-marks

12. Solid

1.h. Container with Solid Consistency and Protective Wrapping and Different Flavours in Each Section

This container is similar to the one above, with the peculiar feature that each section, protected by a wrapping, has a different flavour.

The following is indicated:

12.1. Solid with flavour 1

12.8. Solid with flavour 8

FIG. 3

This figure represents a series of possible external shapes of the container that is the object of the invention. The inventor reserves manufacturing the container with other different shapes so as to increase the attractiveness of this consumable article.

3.a. Cigarette type container

3.b. Container with rounded ends

3.c. Spindle-shaped container

3.d. Trumpet type container

3.e. Bow-tie type container

### DESCRIPTION OF A PREFERRED EMBODIMENT

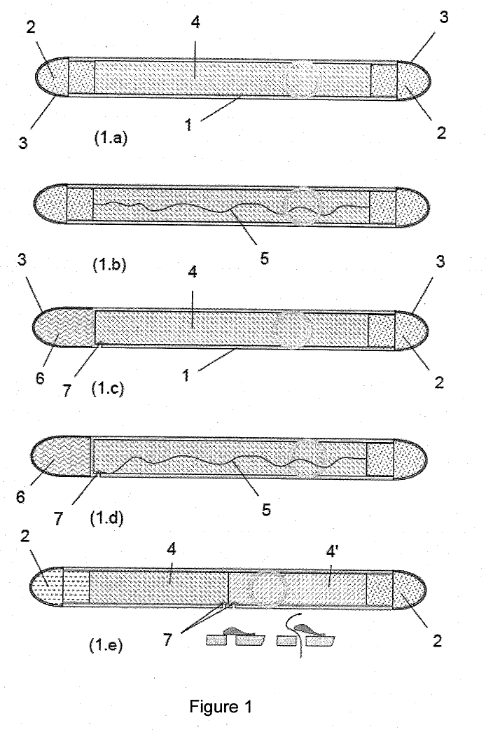

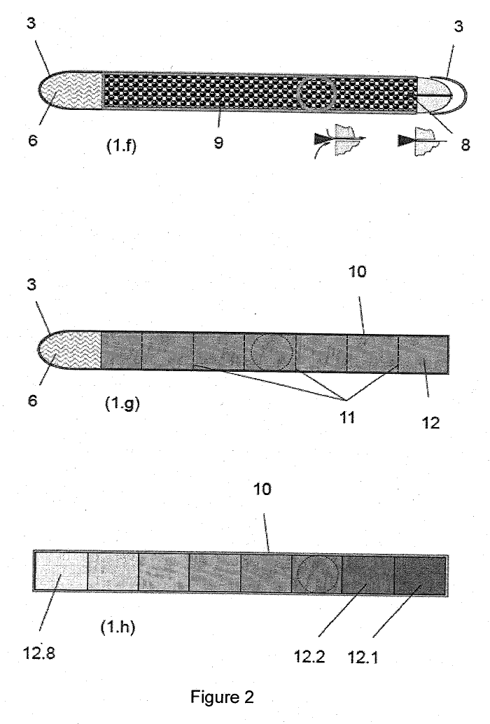

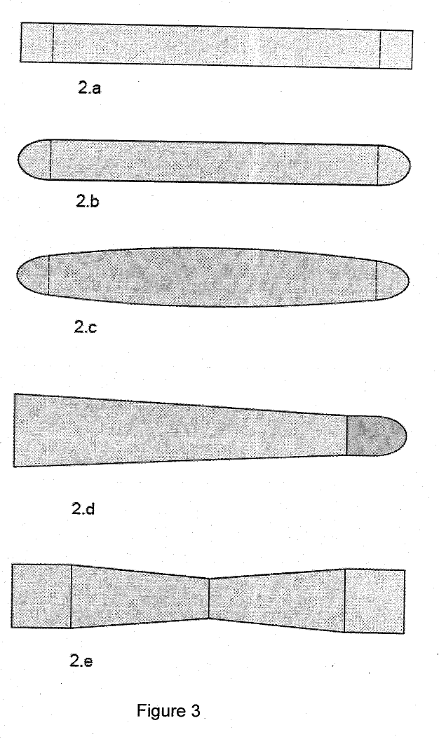

Elongated container for consumables (FIGS. 1 and 2) consisting of a consumable article of the size of a cigarette and with a similar shape, which is used by absorbing the product that it contains, after applying it to the lips of the person who wants to taste it.

In its basic concept, it has a cylindrical, hollow, elongated body (1), which is plugged at both ends by identical mouthpieces for absorption (2) that are perfectly coupled to the body of container (1) filled with a liquid (4) that offers the alternative of very different flavours. Immediately after it is manufactured, a seal (3) is provided which covers each mouthpiece (2) to ensure the air-tightness of container (1) until its contents is consumed. In other options contemplated by the inventor, this seal (3) can cover not only the absorption mouthpieces (2), but also the whole container. To start consuming the article, after removing it from the small box in which it is supplied, which is like the standard cigarette packets, although its size can vary, the cover protecting each unit like an external warranty seal must be removed, taking care not to spill the consumable.

With respect to the materials, body (1) is manufactured preferably from a raw material of the so-called multi-layer type, made up of cellulose, aluminium and polyethylene, which give the article of the invention appropriate consistency for its use, without the danger of spilling consumable (4) contained inside it.

The use of materials with one, two or more layers is not discarded, as well as any other that may be introduced in the future. Seal (3) of mouthpieces (2) is designed with the same type of material including pre-etched marks and a small flange for facilitating the removal thereof.

Absorption mouthpiece (2) is made of a pressed porous material like cellulose, cotton or any other porous material which, with or without small holes, allows liquid (4) in container (1) to pass therethrough while the user applies the appropriate suction action on said mouthpiece (2). Mouthpiece (2) on the opposite side intervenes by allowing the inlet of air therethrough so as not to create a vacuum inside container (1). These mouthpieces can be replaced, in other alternatives, with plugs including a special valve that open when the suction action is produced. Aroma emitter (6) is made of very absorbent pressed material similar to that of mouthpiece (2) and it is also protected with a seal (3) that prevents the product from evaporating until the user removes said seal. As for liquid (4), the inventor contemplates a maximum range of possibilities, always giving preference to sanitary characteristics to ensure complete guarantee. Possible contents will be listed below, as an example.

The elongated container for consumables is designed by the inventor with multiple variations, including those shown in the figures attached to this document, which are worth highlighting.

Liquid Consumable Options

A first variant (FIG. 1.b) is the one wherein, a thread or wick (5) is added to the basic model shown in FIG. 1.a, and fitted inside the container and connected to the two mouthpieces (2), so as to take-up the whole contents via capillary action, and facilitate guiding and removing the liquid through the chosen mouthpiece (2).

Variant (FIG. 1.c) is very similar to the one above, but, in this case, container (1) is closed permanently at one end thereof with the particular feature whereby to facilitate the inlet of air during the suction action, a small one-way valve (7) is fitted. Also, at the opposite end of mouthpiece (2) an aroma emitter (6) module is included, from which pleasant aromas flow once a container (1) is selected for consumption.

Variant (FIG. 1.d) is identical to the one above, but with the particular feature of incorporating a capillary take-up wick (5).

Another variant referring to the case of liquids (FIG. 1.e) consists in dividing the container in two parts noticeably the same size, so as to be able to enjoy two different flavours in one and the same article. Absorption mouthpieces (2) are fitted with their seals (3) at both ends, and also two valves (7) that help to extract the consumable when the suction action is applied from the corresponding mouthpiece (2).

Liquid Gas or Solid Consumable Options

These are represented diagrammatically in FIG. 2.

View (FIG. 1.f) relates to using a consumable (9) that can be kept in a liquid state when it is stored under pressure inside container (1), but which comes out in a gaseous state when it is consumed; in other words, a liquid gas. To this end, a special stopper (8) is fitted into absorption mouthpiece (2), which includes an internal component that affects the closure, and a kind of external press-button that opens the stopper if gentle pressure is applied with the tongue, mouth or hands. Seal (3) protects the mouthpiece until the product starts to be consumed, which is when it has to be removed. In this case, the container material must have greater resistance characteristics and can be made of aluminium, lightweight metal, plastic, polycarbonate and the like, according to those that are currently available and including those that may be developed in the future.

Lastly, the inventor also contemplates solid consumables (12) with just one flavour (FIG. 1.g), or with various successive flavours (FIG. 1.h). In these two cases, all that is required, as in previous cases, is a wrapping (10) that acts as a seal, and which, thanks to a series of pre-marks (10) makes it possible to partially uncover the section that is going to be consumed first. It is understood that, in the case of FIG. 1.h, uncovering the following section, after consuming the first one, implies tasting another different flavour. One special characteristic that each section has is that, if the user desires, it can be removed from the assembly, and be eaten like a sweet, thanks to the marks that make it easy to break. In both cases, it is also possible to add, or not, an aroma emitter (6).

Flavour Options

And turning now to the consumable products that can be included in the elongated container of this invention, it is suffice to say that, apart from all the sanitary and health guarantees that are logically required in this kind of article, the inventor wants to cover the widest range of possibilities, including all kinds of distilled and macerated products, liquor, concentrated products, herbal teas, essences, all kinds of extracts, pressed, dehydrated and lyophilized products, stimulants, calming products, small doses of nicotine, healing plants, recreational, traditional and homoeopathic medicines, aromatherapy products, and, in short, any legalised consumable product.

It is understood that there is an infinite number of combinations of flavours and aromas, as it is the contemporary market that dictates the most sought-after and accepted solutions, without forgetting the above-mentioned variants of preventive or curative medicine.

It is not considered necessary to provide a more extensive description for a person skilled in the art to understand the scope and the advantages derived from the invention, and to develop and put into practice the subject matter thereof. However, it must be understood that the invention has been described according to a preferred embodiment thereof, and therefore it is subject to modifications, without this affecting or altering any of the essential features of this invention. In other words, the terms used to explain this preferred description of the invention, must always be considered in their broadest, non-limiting sense.

What is claimed is:

1. Elongated container for consumables comprising a consumable article intended to be applied to the lips of a person to absorb a product contained therein, the article including a cylindrical, hollow, elongated body, filled with a liquid and plugged at both ends by absorption mouthpieces and seals, wherein the elongated body is made from at least one of the materials selected from the group consisting of cellulose, aluminium and polyethylene, and is formed by at least one sheet of said materials.

2. Elongated container for consumables, according to claim 1, further comprising a capillary take-up wick in the elongated body.

3. Elongated container for consumables comprising a consumable article intended to be applied to the lips of a person to absorb a product contained therein, the article including a cylindrical, hollow, elongated body, filled with a fluid, wherein the elongated body is made from at least one of the materials selected from the group consisting of cellulose, aluminium and polyethylene, and is formed by at least one sheet of said materials, wherein the body is closed permanently at one end thereof by an aroma emitter.

4. Elongated container for consumables, according to claim 1, wherein the fluid is a liquid and the body is divided into two parts with different liquids in each part and valves that allow inlet of air into the body.

5. Elongated container for consumables, according to claim 3, wherein the fluid is a liquid gas and the body includes a stopper at an opposite end thereof.

6. Elongated container for consumables comprising a consumable article, the article including a solid cylinder with at least one flavour in consecutive sections of shorter cylinders, and pre-marks for separating the consecutive sections.

7. Elongated container for consumables, according to claim 1, wherein the article has one of the following shapes:
a cylindrical cigarette shape without rounded ends,
a cylindrical cigarette shape with rounded ends,
a spindle,
a trumpet and
a bow-tie.

8. Elongated container for consumables, according to claim 1, wherein the liquid includes preventive and curative medicinal products.

9. Elongated container for consumables, according to claim 1, wherein the elongated body is made with multi-layers sheets of said materials.

10. Elongated container for consumables, according to claim 3, further comprising a capillary take-up wick in the elongated body.

11. Elongated container for consumables, according to claim 3, further including a valve that allows inlet of air into the body.

12. Elongated container for consumables, according to claim 6, wherein there are a plurality of different flavours in said consecutive sections.

13. Elongated container for consumables, according to claim 6, wherein the body is closed at one end thereof by an aroma emitter.

14. Elongated container for consumables, according to claim 3, wherein the article has one of the following shapes:
a cylindrical cigarette shape without rounded ends,
a cylindrical cigarette shape with rounded ends,
a spindle,
a trumpet and
a bow-tie.

15. Elongated container for consumables, according to claim 3, wherein the fluid includes preventive and curative medicinal products.

16. Elongated container for consumables, according to claim 6, wherein the article has one of the following shapes:
a cylindrical cigarette shape without rounded ends,
a cylindrical cigarette shape with rounded ends,
a spindle,
a trumpet and
a bow-tie.

17. Elongated container for consumables, according to claim 6, wherein the solid includes preventive and curative medicinal products.
